(19) United States
(12) Patent Application Publication
(10) Pub. No.: US 2010/0184905 A1
(43) Pub. Date: Jul. 22, 2010

(54) COMPOSITE MATERIAL TRANSPARENT TO RADIO FREQUENCY SIGNALS, HOUSING FOR ELECTRONIC DEVICE MADE FROM SAME AND METHOD FOR MAKING SUCH HOUSING

(75) Inventor: GA-LANE CHEN, Santa Clara, CA (US)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/550,861

(22) Filed: Aug. 31, 2009

(30) Foreign Application Priority Data
Jan. 16, 2009 (CN) 200910300244.0

(51) Int. Cl. C08K 3/04; C08K 3/08; C08G 69/26; C08L 67/00; B29C 45/00

(52) U.S. Cl. 524/440; 524/441; 524/566; 524/606; 524/612; 524/601; 264/328.1; 264/328.14; 977/742; 977/750; 977/752

(57) ABSTRACT

An exemplary composite material includes polymer, carbon nanotubes (CNTs) and metallic particles. The CNTs and the metallic particles are randomly but generally evenly and discretely dispersed in the polymer. The composite material is characterized in that it allows radio frequency signals to pass therethrough.

### BACKGROUND

1. Technical Field

The present disclosure relates to a composite material that allows radio frequency signals to pass therethrough, a housing for an electronic device made from the composite material, and a method for making the housing having the composite material.

2. Description of Related Art

Generally, housings of electronic devices are made of plastic. In order to make plastic housings of electronic devices have a metallic appearance, a non-conductive vacuum metallization (NCVM) process is used to treat the plastic housings.

However, the NCVM process is complicated, and the cost of the NCVM process is correspondingly high. Furthermore, some materials used in NCVM processes, such as indium or tin, may be harmful to humans.

Therefore, a new composite material, a new housing and a new method for making the housing are desired to overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an isometric view of a housing of an electronic device according to an exemplary embodiment of the present disclosure, showing part of a sidewall of the housing cut away.

FIG. 2 is an enlarged view of an area marked II of FIG. 1, showing a structure of the sidewall greatly magnified.

### DETAILED DESCRIPTION

Various embodiments will now be described in detail below with reference to the drawings.

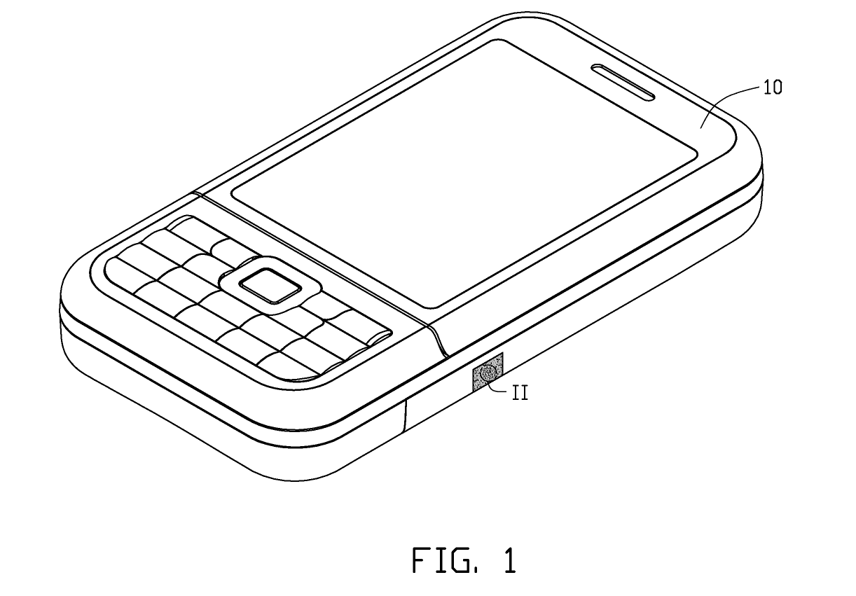

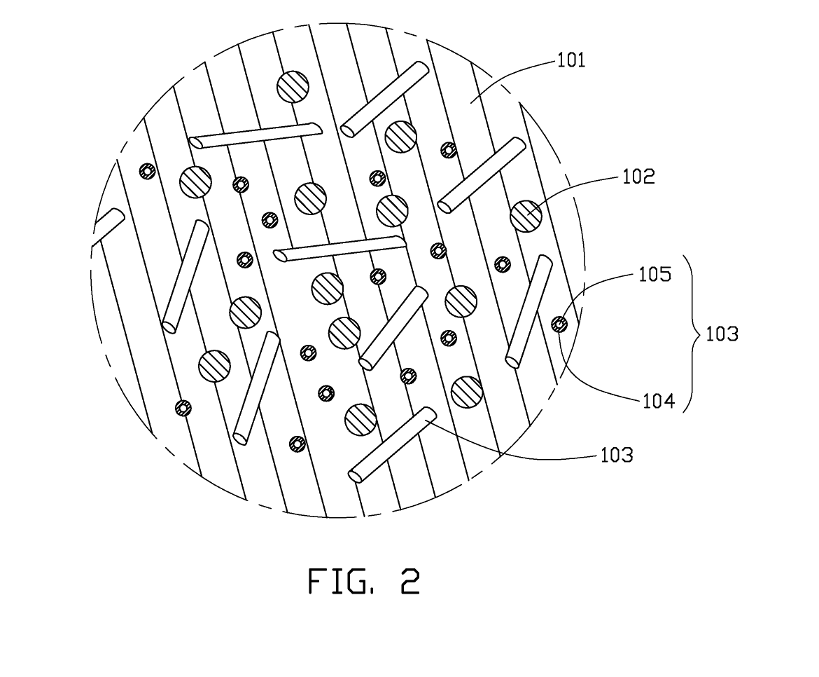

Referring to FIGS. 1-2, a housing 10 for an electronic device is shown. In the present embodiment, the electronic device is a cell phone. The housing 10 is made of a composite material. The composite material is electrically non-conductive, but allows radio frequency signals to pass therethrough.

The composite material includes a polymer 101, a plurality of carbon nanotubes (CNTs) 103, and a plurality of metallic particles 102. The CNTs 103 and the metallic particles 102 are each randomly but generally evenly and discretely dispersed in the polymer 101. A weight ratio of the CNTs 103 in the composite material is in a range from 0.1% to 8%, a weight ratio of the metallic particles 102 in the composite material is in a range from 2% to 19.9%, and a weight ratio of the polymer 101 in the composite material is in a range from 80% to 90%.

A size of each metallic particle 102 can be in an approximate range from 1 nm to 20 nm. The material of the metallic particles 102 can be powder selected from the group consisting of aluminum, silver, copper, chromium, titanium, etc, depending on a desired color of the housing 10. For example, in order to achieve a color of silver gray, the material of the metallic particles 102 can be powder selected from the group consisting of silver, chromium and titanium. In order to achieve a reddish-purple (i.e. burgundy) color, the material of the metallic particles 102 can be a mixture of powder of copper and powder of one of silver, chromium and titanium. Thus in a typical embodiment, the metallic particles 102 are grains or granules of powder.

The polymer can be made of material selected from the group consisting of polycarbonate (PC), acrylonitrile butadiene styrene (ABS), glass fiber, polyphthalamide (PPA), polyphenylene oxide (PPO), and any combination thereof.

The CNTs 103 can be single-walled CNTs or multi-walled CNTs. Each CNT 103 includes a sidewall 104 and a space 105 defined within the sidewall. A diameter of each CNT 103 can be in an approximate range from 0.5 nm to 10 nm, and a length of each CNT 103 can be in a range from about 4 nm to 80 nm. Radio frequency signals that enter the housing 10 can enter the spaces 105 of the CNTs 103, and can transmit through the spaces 105 within the CNTs 103. Also, radio frequency signals can transmit through the polymer 101 between the metallic particles 102 and the CNTs 103, and be reflected by the sidewalls 104 of the CNTs 103 and the metallic particles 102. Thus, radio frequency signals can transmit through the housing 10.

An exemplary method for making the housing 10 is described in detail below:

First, the plurality of CNTs 103 are provided. The CNTs 103 can be made by arc discharge.

Second, the CNTs 103 and the metallic particles 102 (e.g., in the form of powder) are heated together to a temperature in a range from 150° Cl to 300° C., and blended evenly. Preferably, the CNTs 103 and the metallic particles 102 are heated to a temperature in a range from 200° C. to 250° C. After the CNTs 103 and the metallic particles 102 have been mixed evenly, the mixture of the CNTs 103 and the metallic particles 102 can be cooled to a predetermined temperature, e.g., room temperature.

Third, the mixture of the CNTs 103 and the metallic particles 102 is heated together with the polymer 101 to a temperature in a range from 75° C. to 150° C., and blended evenly to obtain the composite material.

Fourth, the composite material is heated to a temperature in a range from 250° C. to 350° C., and then fed into an injection molding machine to form the housing 10.

In summary, since the composite material includes the metallic particles 102, the housing 10 has a metallic appearance. Because the metallic particles 102 and the CNTs 103 are discretely dispersed in the polymer 101, and the composite material is electrically non-conductive, radio frequency signals can pass through the composite material.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope and spirit of the appended claims.

What is claimed is:

1. A composite material comprised of polymer, a plurality of carbon nanotubes (CNTs) and a plurality of metallic particles, the CNTs and the metallic particles each being randomly but generally evenly and discretely dispersed in the polymer, the composite material characterized in that it allows radio frequency signals to pass therethrough.

2. The composite material of claim 1, wherein the material of the metallic particles is powder selected from the group consisting of aluminum, silver, copper, chromium, and titanium.

3. The composite material of claim 1, wherein the polymer is comprised of material selected from the group consisting of polycarbonate (PC), acrylonitrile butadiene styrene (ABS), glass fiber, polyphthalamide (PPA), polyphenylene oxide (PPO), and any combination thereof.

4. The composite material of claim 1, wherein each CNT is one of single-walled and multi-walled.

5. The composite material of claim 1, further characterized in that it is electrically non-conductive.

6. The composite material of claim 1, wherein a weight ratio of the CNTs in the composite material is in a range from 0.1% to 8%.

7. The composite material of claim 1, wherein a weight ratio of the metallic particles in the composite material is in a range from 2% to 19.9%.

8. The composite material of claim 1, wherein a weight ratio of the polymer in the composite material is in a range from 80% to 90%.

9. A housing for an electronic device, the housing being made of composite material, the composite material being comprised of polymer, a plurality of carbon nanotubes (CNTs) and a plurality of metallic particles, the CNTs and the metallic particles each being randomly but generally evenly and discretely dispersed in the polymer.

10. The housing of claim 9, wherein the material of the metallic particles is powder selected from the group consisting of aluminum, silver, copper, chromium, and titanium.

11. The housing of claim 9, wherein the polymer is comprised of material selected from the group consisting of polycarbonate (PC), acrylonitrile butadiene styrene (ABS), glass fiber, polyphthalamide (PPA), polyphenylene oxide (PPO), and any combination thereof.

12. The housing of claim 9, wherein each CNT is one of single-walled and multi-walled.

13. The housing of claim 9, characterized in that it is electrically non-conductive and transparent to radio frequency signals.

14. The housing of claim 9, wherein a weight ratio of the CNTs in the composite material is in a range from 0.1% to 8%.

15. The housing of claim 9, wherein a weight ratio of the metallic particles in the composite material is in a range from 2% to 19.9%.

16. The housing of claim 9, wherein a weight ratio of the polymer in the composite material is in a range from 80% to 90%.

17. A method for making a housing for an electronic device, the method comprising: heating a plurality of carbon nanotubes (CNTs), a plurality of metallic particles, and an amount of polymer together, and blending the polymer, the CNTs and the metallic particles, thus obtaining a composite material; and
forming the housing by injection molding the composite material.

18. The method of claim 17, wherein the heating of the CNTs, the metallic particles, and the polymer is to a temperature in a range from 75° C. to 150° C.

19. The method of claim 17, wherein before heating and blending the CNTs, the metallic particles, and the polymer together, the CNTs and the metallic particles are first heated and mixed together.
